(19) United States
(12) Patent Application Publication
(10) Pub. No.: US 2026/0085165 A1
(43) Pub. Date: Mar. 26, 2026

(54) ANTI-FINGERPRINT COMPOSITION, CURED ARTICLE LAYER, ANTI-FINGERPRINT ARTICLE, AND HARD COAT FILM

(71) Applicant: LINTEC CORPORATION, Tokyo (JP)

(72) Inventor: Hiroki HOSHINO, Tokyo (JP)

(73) Assignee: LINTEC CORPORATION, Tokyo (JP)

(21) Appl. No.: 19/130,457

(22) PCT Filed: Nov. 16, 2023
(86) PCT No.: PCT/JP2023/041223

§ 371 Date: May 15, 2025

(30) Foreign Application Priority Data
Nov. 17, 2022 (JP) 2022-184281

(51) Int. Cl. C08J 7/046; C08L 75/04; C09D 4/06; C09D 5/16; C09D 7/48; C09D 175/04; G02B 1/14

(52) U.S. Cl. CPC C08J 7/046; C08L 75/04; C09D 4/06; C09D 5/16; C09D 7/48; C09D 175/04; G02B 1/14; C08J 2375/04

(57) ABSTRACT

An anti-fingerprint composition comprising: at least one selected from a polyfunctional (meth)acrylate-based monomer, a (meth)acrylate-based prepolymer, and a urethane-based polymer; and a plasticizer, wherein when a cured article layer having a thickness of 10 μm and formed by curing the anti-fingerprint composition is formed on a polyethylene terephthalate film having a thickness of 125 μm and a surface of the cured article layer is rubbed back and forth 5 times over a distance of 10 cm using a #0000 steel wool with a load of 125 g/cm², the number of scratches generated is 10 or less. According to such a cured article layer formed using the anti-fingerprint composition, the scratch resistance is excellent and a fingerprint residue of sebum can be made invisible without the need to wipe off the fingerprint residue.

### TECHNICAL FIELD

The present invention relates to an anti-fingerprint composition, a cured article and a cured article layer of the anti-fingerprint composition, an anti-fingerprint article, and a hard coat film having fingerprint resistance.

### BACKGROUND ART

In recent years, touch panels that serve as both a display device and an input means are widely used in various electronic devices. Such touch panels are often operated with fingers, so fingerprints caused by finger sebum are usually left on the surface of the touch panel. When fingerprints are thus left on the surface of the touch panel, the appearance is deteriorated and the displayed image becomes difficult to see.

Meanwhile, a hard coat film having a hard coat layer is often provided on the surface of such touch panels to prevent scratches. In this context, Patent Document 1 proposes a hard coat film that makes it easy to wipe off fingerprints left on the panel.

### PRIOR ART DOCUMENTS

### Patent Documents

Patent Document 1: JP2014-232277A

### SUMMARY OF THE INVENTION

### Problems to be Solved by the Invention

Although the hard coat film described in Patent Document 1 allows fingerprints to be easily wiped off, wiping off the sebum is still required.

The present invention has been made in consideration of such an actual situation, and objects of the present invention include providing an anti-fingerprint composition, a cured article, a cured article layer, an anti-fingerprint article, and a hard coat film that are excellent in the scratch resistance and can make the fingerprint residue of sebum invisible without the need to wipe off the fingerprint residue.

### Means for Solving the Problems

To achieve the above objects, first, the present invention provides an anti-fingerprint composition comprising: at least one selected from a polyfunctional (meth)acrylate-based monomer, a (meth)acrylate-based prepolymer, and a urethane-based polymer; and a plasticizer, wherein when a cured article layer having a thickness of 10 μm and formed by curing the anti-fingerprint composition is formed on a polyethylene terephthalate film having a thickness of 125 μm and a surface of the cured article layer is rubbed back and forth 5 times over a distance of 10 cm using a #0000 steel wool with a load of 125 g/cm², the number of scratches generated is 10 or less (Invention 1).

The cured article obtained by curing the anti-fingerprint composition according to the above invention (Invention 1) exhibits excellent scratch resistance due to the above physical properties. Moreover, in the cured article (layer) obtained by curing the anti-fingerprint composition containing the above components, even if fingerprint residue of sebum is left on the surface of the cured article (layer), the sebum is absorbed into the cured article (layer) over time. It is therefore possible to make the fingerprint residue of sebum invisible without the need to wipe off the fingerprint residue.

In the above invention (Invention 1), the anti-fingerprint composition preferably contains a crosslinker (Invention 2).

Second, the present invention provides a cured article formed by curing the anti-fingerprint composition (Invention 1, 2) (Invention 3)

Third, the present Invention provides a cured article layer formed by curing the anti-fingerprint composition (Invention 1, 2) in a layered form (Invention 4).

Fourth, the present Invention provides an anti-fingerprint article having the cured article layer (Invention 4) on its surface (Invention 5).

Fifth, the present Invention provides a hard coat film comprising: a base material film; and a hard coat layer provided on at least one surface side of the base material film, wherein the hard coat layer is formed by curing an anti-fingerprint composition containing: at least one selected from a polyfunctional (meth)acrylate-based monomer, a (meth)acrylate-based prepolymer, and a urethane-based polymer; and a plasticizer, wherein when a surface of the hard coat layer is rubbed back and forth 5 times over a distance of 10 cm using a #0000 steel wool with a load of 125 g/cm², the number of scratches generated is 10 or less (Invention 6).

In the above invention (Invention 6), the anti-fingerprint composition preferably contains a crosslinker (Invention 7).

In the above invention (Invention 6, 7), the hard coat layer preferably has a thickness of 0.5 μm or more and 50 μm or less (Invention 8).

The hard coat film according to the above invention (Invention or inventions 6 to 8) is preferably for optical use (Invention 9).

### Advantageous Effect of the Invention

The anti-fingerprint composition, cured article, cured article layer, anti-fingerprint article, and hard coat film according to the present invention are excellent in the scratch resistance and can make the fingerprint residue of sebum invisible without the need to wipe off the fingerprint residue.

### BRIEF DESCRIPTION OF THE DRAWINGS

FIG. 1 is a cross-sectional view of a hard coat film according to one embodiment of the present invention.

### EMBODIMENTS FOR CARRYING OUT THE INVENTION

Hereinafter, one or more embodiments of the present invention will be described.

### <Anti-fingerprint Composition>

An anti-fingerprint composition (which may be referred to as an “anti-fingerprint composition F,” hereinafter) according to one embodiment of the present invention contains: at least one selected from a polyfunctional (meth)acrylate-based monomer, a (meth)acrylate-based prepolymer, and a urethane-based polymer (which may be referred to as a “curable component (A),” hereinafter); and a plasticizer (B). When a cured article layer having a thickness of 10 μm and formed by curing the anti-fingerprint composition F is formed on a polyethylene terephthalate film having a thickness of 125 μm and a surface of the cured article layer is rubbed back and forth 5 times over a distance of 10 cm using a #0000 steel wool with a load of 125 g/cm², the number of scratches generated is preferably 10 or less.

The cured article obtained by curing the anti-fingerprint composition F according to the present embodiment exhibits excellent scratch resistance due to the above physical properties, and when the cured article is layered, it serves as a hard coat layer. Moreover, in the cured article (layer) obtained by curing the anti-fingerprint composition F containing the curable component (A) and plasticizer (B), even if fingerprint residue of sebum is left on the surface of the cured article (layer), the sebum is absorbed into the cured article (layer) over time. It is therefore possible to make the fingerprint residue of sebum invisible without the need to wipe off the fingerprint residue. This effect may be referred to as a “fingerprint resistance.”

In the present specification, (meth)acrylate means both acrylate and methacrylate. The same applies to other similar terms.

### 1. Each Component

### (1) Curable Component (A)

The polyfunctional (meth)acrylate-based monomer, the (meth)acrylate-based prepolymer, and the urethane-based polymer, which can all be used as the curable component (A) in the present embodiment, are materials that have curing properties, and may be thermosetting or active energy ray curing. The polyfunctional (meth)acrylate-based monomer, (meth)acrylate-based prepolymer, and urethane-based polymer may each be used alone or any two or three types may also be used in combination.

Examples of the polyfunctional (meth)acrylate-based monomer include polyfunctional (meth)acrylates such as 1,4-butanediol di(meth)acrylate, 1,6-hexanediol di(meth)acrylate, neopentyl glycol di(meth)acrylate, polyethylene glycol di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, allylated cyclohexyl di(meth)acrylate, isocyanurate di(meth)acrylate, trimethylol propane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(acryloxyethyl)isocyanurate, propionic acid-modified dipentaerythritol penta(meth)acrylate, dipentaerythritol hexa(meth)acrylate, ethylene oxide-modified dipentaerythritol hexa(meth)acrylate, and caprolactone-modified dipentaerythritol hexa(meth)acrylate. These may each be used alone or two or more types may also be used in combination.

Examples of the (meth)acrylate-based prepolymer include polyester acrylate-based, epoxy acrylate-based, urethane acrylate-based, and polyol acrylate-based prepolymers.

The polyester acrylate-based prepolymer can be obtained, for example, through preparing a polyester oligomer having hydroxyl groups at both ends, which is obtained by condensation of a polycarboxylic acid and a polyalcohol, and esterifying the hydroxyl groups of the polyester oligomer with (meth)acrylic acid, or through preparing an oligomer obtained by adding an alkylene oxide to a polycarboxylic acid and esterifying the hydroxyl group at an end of the oligomer with (meth)acrylic acid.

The epoxy acrylate-based prepolymer can be obtained, for example, through reacting (meth)acrylic acid with the oxirane ring of a relatively low-molecular-weight bisphenol-type epoxy resin or novolak-type epoxy resin to esterify it.

The urethane acrylate-based prepolymer can be obtained, for example, through preparing a polyurethane oligomer obtained by a reaction between a polyether polyol or a polyester polyol and a polyisocyanate and esterifying the polyurethane oligomer with (meth)acrylic acid.

The polyol acrylate-based prepolymer can be obtained, for example, through esterifying a hydroxyl group of a polyether polyol with (meth)acrylic acid.

The (meth)acrylate-based prepolymer may have a reactive functional group that reacts with a crosslinker (C), which will be described later. Examples of such reactive functional groups include hydroxyl groups, carboxyl groups, and amino groups.

The weight-average molecular weight of the (meth)acrylate-based prepolymer is preferably 1,000 to 60,000, particularly preferably 3,000 to 40,000, and further preferably 5,000 to 30,000. The weight-average molecular weight in the present specification refers to a standard polystyrene equivalent value that is measured by using a gel permeation chromatography (GPC) method.

One type of the above prepolymer may be used alone or two or more types may also be used in combination.

The urethane-based polymer is generally obtained by reacting a polyol compound with a polyisocyanate compound. Examples of polyol compounds include polyester polyol, polyether polyol, polyether ester polyol, polyester amide polyol, acrylic polyol, polycarbonate polyol, polyhydroxy alkane, and polyurethane polyol. These may each be used alone or two or more types may also be used in combination.

Examples of polyisocyanate compounds include aliphatic diisocyanate, alicyclic diisocyanate, aromatic diisocyanate, araliphatic diisocyanates, and triisocyanate. These may each be used alone or two or more types may also be used in combination.

The urethane-based polymer may have a reactive functional group that reacts with the crosslinker (C), which will be described later. Examples of such reactive functional groups include hydroxyl groups, carboxy groups, and amino groups. Among these, hydroxyl groups are preferred because they are easily retained during the production steps for the urethane-based polymer.

The weight-average molecular weight of the urethane-based polymer is preferably 1,000 to 300,000, more preferably 5,000 to 200,000, particularly preferably 10,000 to 100,000, and further preferably 20,000 to 60,000.

Among the above curable components (A), urethane-based polymers are preferred because they are excellent in the scratch resistance even when the plasticizer (B) is compounded, and because they are easy to exhibit sebum absorbency by the plasticizer (B). Among these, urethane-based polymers having hydroxyl groups are particularly preferred when an isocyanate-based crosslinker is used as the crosslinker (C), which will be described later. Such a combination effectively increases the hardness of the obtained cured article, resulting in better scratch resistance.

### (2) Plasticizer (B)

The plasticizer (B) is usually a material that softens resin, but in the present embodiment, the plasticizer (B) is allowed to be present in a cured article having hard coat properties and can thereby absorb sebum left on the surface of the cured article.

Examples of the plasticizer (B) include: citric acid-based plasticizers such as acetyl tributyl citrate and acetyl triethyl citrate; phthalic ester-based plasticizers such as dimethyl phthalate, diethyl phthalate, dibutyl phthalate, dioctyl phthalate, di-n-octyl phthalate, and dicyclohexyl phthalate; trimellitic ester-based plasticizers such as trioctyl trimellitate, triisononyl trimellitate, and triisodecyl trimellitate; adipic acid-based plasticizers such as dioctyl adipate, diisononyl adipate, and diisodecyl adipate; polyester-based plasticizers such as phthalic acid-based polyesters; phosphate-based plasticizers such as tricresyl phosphate, trioctyl phosphate, and triphenyl phosphate; epoxy-based plasticizers such as epoxidized linseed oil and epoxidized butyl stearate; liquid polybutene, mineral oil, lanolin, wax, liquid polyisoprene, liquid polyacrylate, triethanolamine, alkylamine, amine alkylene oxide adduct, glycerin, diglycerin, and silicone oil. These may each be used alone or two or more types may also be used in combination.

Among the above, citric acid-based plasticizers are preferred from the viewpoint of exhibiting sebum absorbency while maintaining scratch resistance, and acetyl tributyl citrate is particularly preferred.

The content of the plasticizer (B) in the anti-fingerprint composition F according to the present embodiment is preferably 0.1 to 100 mass parts, more preferably 1.0 to 75 mass parts, particularly preferably 3.0 to 50 mass parts, further preferably 6.0 to 25 mass parts, and especially preferably 9.0 to 15 mass parts, with respect to 100 mass parts of the curable component (A). This allows the sebum absorbency to be effectively exhibited while maintaining the scratch resistance.

### (3) Crosslinker (C)

The anti-fingerprint composition F according to the present embodiment preferably contains a crosslinker (C). By containing the crosslinker (C), the curable component (A) can be crosslinked, and the hardness of the obtained cured article can be increased, resulting in better scratch resistance (hard coat properties).

The crosslinker (C) may be one that can react with the curable component (A) to crosslink the curable component (A). Examples of the crosslinker (C) include isocyanate-based crosslinkers, epoxy-based crosslinkers, amine-based crosslinkers, melamine-based crosslinkers, aziridine-based crosslinkers, hydrazine-based crosslinkers, aldehyde-based crosslinkers, oxazoline-based crosslinkers, metal alkoxide-based crosslinkers, metal chelate-based crosslinkers, metal salt-based crosslinkers, and ammonium salt-based crosslinkers.

When the curable component (A) is a urethane-based polymer (particularly a urethane-based polymer having hydroxyl groups), it is preferred to use an isocyanate-based crosslinker that easily crosslinks the urethane-based polymer. One type of the crosslinker (C) may be used alone or two or more types may also be used in combination.

The isocyanate-based crosslinker contains at least a polyisocyanate compound. Examples of the polyisocyanate compound include aromatic polyisocyanates such as tolylene diisocyanate, diphenylmethane diisocyanate and xylylene diisocyanate, aliphatic polyisocyanates such as hexamethylene diisocyanate, alicyclic polyisocyanates such as isophorone diisocyanate and hydrogenated diphenylmethane diisocyanate, biuret bodies and isocyanurate bodies thereof, and adduct bodies that are reaction products with low molecular active hydrogen-containing compounds such as ethylene glycol, propylene glycol, neopentyl glycol, trimethylol propane, and castor oil. Among these, isocyanurate bodies of aliphatic polyisocyanates are preferred from the viewpoint of exhibiting the sebum absorbency while maintaining the scratch resistance.

The content of the crosslinker (C) in the anti-fingerprint composition F according to the present embodiment is preferably 1 to 100 mass parts, more preferably 5 to 75 mass parts, particularly preferably 10 to 50 mass parts, and further preferably 15 to 25 mass parts, with respect to 100 mass parts of the curable component (A). This allows the scratch resistance (hard coat properties) to be more excellent while maintaining the sebum absorbency by the plasticizer (B).

### (4) Leveling Agent (D)

It is also preferred that the anti-fingerprint composition F according to the present embodiment should contain a leveling agent (D). This allows the formed cured article layer to have a uniform thickness without streaky defects or unevenness and to exhibit excellent optical properties and appearance.

Examples of the leveling agent (D) include silicone-based leveling agents, fluorine-based leveling agents, acrylic-based leveling agents, and vinyl-based leveling agents, among which silicone-based leveling agents are preferred from the viewpoints of leveling properties and compatibility with other components. One type of the leveling agent (D) may be used alone or two or more types may also be used in combination.

The leveling agent (D) may be modified or unmodified. The leveling agent (D) may or may not have a reactive group, but from the viewpoint of effectively exhibiting the leveling properties while maintaining the scratch resistance (hard coat properties) and sebum absorbency, those having reactive groups are preferred, and those having hydroxyl groups are particularly preferred.

The content of the leveling agent (D) in the anti-fingerprint composition F according to the present embodiment is preferably 0.01 to 10 mass parts, more preferably 0.1 to 5 mass parts, and further preferably 0.3 to 2 mass parts, with respect to 100 mass parts of the curable component (A). This allows the leveling properties to be effectively exhibited while maintaining the scratch resistance (hard coat property) and sebum absorbency.

### (5) Other Components

The anti-fingerprint composition F according to the present embodiment may contain various additives in addition to the above components. Examples of the various additives include photopolymerization initiators, fillers, dispersants, antifouling agents, ultraviolet absorbers, infrared absorbers, antioxidants, light stabilizers, antistatic agents, silane coupling agents, antiaging agents, thermal polymerization inhibitors, colorants, surfactants, storage stabilizers, glidants, and defoamers.

### 2. Preparation of Anti-fingerprint Composition

The anti-fingerprint composition F according to the present embodiment can be prepared by mixing the curable component (A), the plasticizer (B), and optionally the crosslinker (C), the leveling agent (D), additives, etc., preferably in a solvent.

### <Cured Article>

The cured article according to one embodiment of the present invention is formed by curing the anti-fingerprint composition F according to the aforementioned embodiment. The cured article according to the present embodiment exhibits excellent scratch resistance and fingerprint resistance.

To cure the anti-fingerprint composition F according to the aforementioned embodiment, it is preferred to cure it by heat or by active energy rays, depending on the type of the anti-fingerprint composition F.

The heating temperature in the case of heat curing is preferably 15° C. to 100° C., particularly preferably 18° C. to 60° C., and further preferably 22° C. to 40° C. The heating time is preferably 1 to 14 days, particularly preferably 2 to 10 days, and further preferably 3 to 7 days.

Examples of the active energy rays include ultraviolet rays and electron rays. Irradiation with ultraviolet rays can be performed by using a high-pressure mercury lamp, a Heraeus H lamp, a xenon lamp, or the like, and the irradiance level of ultraviolet rays may be preferably about 50 to 1,000 mW/cm² as the illuminance and about 50 to 1,000 mJ/cm² as the light amount. On the other hand, irradiation with electron rays can be performed by using an electron ray accelerator or the like, and the irradiance level of electron rays may be preferably about 10 to 1,000 krad.

### <Cured Article Layer>

The cured article layer according to one embodiment of the present invention is formed by curing the anti-fingerprint composition F according to the aforementioned embodiment in a layered form, and is a so-called hard coat layer. The cured article layer according to the present embodiment exhibits excellent scratch resistance and fingerprint resistance.

The thickness of the cured article layer according to the present embodiment is preferably 0.5 to 50 μm, more preferably 1.0 to 30 μm, particularly preferably 2.0 to 20 μm, further preferably 3.0 to 15 μm, and especially preferably 5.0 to 12 μm. This allows excellent scratch resistance and sebum absorbency to be exhibited.

To form the cured article layer according to the present embodiment, the coating liquid of the anti-fingerprint composition F according to the aforementioned embodiment may be applied to a desired object, and the coating layer formed by drying may be cured.

The coating liquid of the anti-fingerprint composition F may be the anti-fingerprint composition F itself, or may contain a solvent as desired. The solvent can be used to improve the coating properties, adjust the viscosity, adjust the solid concentration, etc., and any solvent may be used, provided that it dissolves or disperses each component. Specific examples of the solvent include: alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, and γ-butyrolactone; ethers such as ethylene glycol monomethyl ether (methyl cellosolve), ethylene glycol monoethyl ether (ethyl cellosolve), diethylene glycol monobutyl ether (butyl cellosolve), and propylene glycol monomethyl ether; aromatic hydrocarbons such as benzene, toluene, and xylene; and amides such as dimethylformamide, dimethylacetamide, and N-methylpyrrolidone.

The concentration/viscosity of the coating liquid of the anti-fingerprint composition F is not particularly limited, provided that it falls within the range that allows coating, and can be appropriately selected depending on the situation. For example, the anti-fingerprint composition F is diluted so that the concentration is 10 to 60 mass %.

Application of the coating liquid of the anti-fingerprint composition F may be performed by an ordinary method, for example, by a bar coating method, a knife coating method, a roll coating method, a blade coating method, a die coating method, or a gravure coating method.

Drying of the coating liquid after application is preferably performed by heat treatment. The heating temperature of the heat treatment is preferably 50° C. to 150° C. and particularly preferably 70° C. to 120° C. The heating time is preferably 10 seconds to 10 minutes and particularly preferably 50 seconds to 2 minutes.

The curing method and curing conditions for the coating layer of the anti-fingerprint composition F are as described previously.

### <Anti-fingerprint Article>

The anti-fingerprint article according to one embodiment of the present invention is an article having the aforementioned cured article layer on its surface. The anti-fingerprint article according to the present embodiment exhibits excellent scratch resistance and fingerprint resistance on the surface of the cured article layer.

The type of article is not particularly limited and may be one that requires scratch resistance and fingerprint resistance, and generally, an article with a certain degree of hardness and smoothness is selected. Examples of such articles include resin products (including molded products, films, etc.), glass products, metal products, and ceramic products.

### <Hard Coat Film>

The hard coat film according to one embodiment of the present invention includes a base material film and a hard coat layer provided on at least one surface side of the base material film. The hard coat layer is formed by curing an anti-fingerprint composition (which may be referred to as an “anti-fingerprint composition F′,” hereinafter) containing: at least one selected from a polyfunctional (meth)acrylate-based monomer, a (meth)acrylate-based prepolymer, and a urethane-based polymer; and a plasticizer. When a surface of the above hard coat layer is rubbed back and forth 5 times over a distance of 10 cm using a #0000 steel wool with a load of 125 g/cm², the number of scratches generated is preferably 10 or less.

The hard coat film according to the present embodiment exhibits excellent scratch resistance due to the above physical properties. Moreover, in the hard coat layer formed by curing the anti-fingerprint composition F′ containing the curable component (A) and the plasticizer (B), even if a fingerprint residue of sebum is left on the surface of the hard coat layer, the sebum is absorbed into the hard coat layer over time. It is therefore possible to make the fingerprint residue of sebum invisible without the need to wipe off the fingerprint residue, thus resulting in excellent fingerprint resistance. Furthermore, the surface of the hard coat layer is excellent in the finger slippage, and the hard coat film according to the present embodiment is therefore suitable as the surface layer of a touch panel, etc.

The anti-fingerprint composition F′ according to the present embodiment has the same composition as that of the anti-fingerprint composition F according to the aforementioned embodiment, except that the physical properties according to the scratch resistance test are not required.

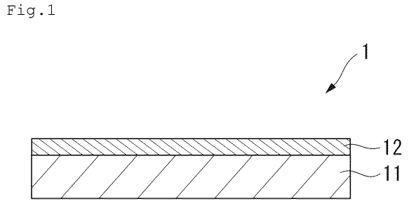

The hard coat film according to the present embodiment will be described below with reference to the drawings. FIG. 1 is a cross-sectional view of a hard coat film according to one embodiment of the present invention. Hard coat film 1 according to the present embodiment includes a base material film 11 and a hard coat layer 12 provided on one surface side of the base material film 11.

### 1. Each Element

### (1) Hard Coat Layer

The hard coat layer 12 of the hard coat film 1 according to the present embodiment is formed by curing the anti-fingerprint composition F′ containing at least one selected from a polyfunctional (meth)acrylate-based monomer, a (meth)acrylate-based prepolymer, and a urethane-based polymer (curable component (A)) and a plasticizer (B).

Details of the components such as the curable component (A) and plasticizer (B) and the curing method for the anti-fingerprint composition F′ are the same as those in the aforementioned embodiment. The thickness of the hard coat layer 12 is the same as that of the cured article layer in the aforementioned embodiment.

### (2) Base Material Film

Although there are no particular limitations, it is preferred to use a resin film as the base material film 11, and in the case of optical applications in particular, it is preferred to use a resin film having a predetermined transparency.

Examples of such resin films include films of polyesters such as polyethylene terephthalate, polybutylene terephthalate, and polyethylene naphthalate, polyolefin films such as polyethylene films and polypropylene films, cellophane, diacetyl cellulose films, triacetyl cellulose films, acetyl cellulose butyrate films, polyvinyl chloride films, polyvinylidene chloride films, polyvinyl alcohol films, ethylene-vinyl acetate copolymer films, polystyrene films, polycarbonate films, polymethylpentene films, polysulfone films, polyetheretherketone films, polyethersulfone films, polyether imide films, fluororesin films, polyamide films, acrylic resin films, polyurethane resin films, norbornene-based polymer films, cyclic olefin-based polymer films, cyclic conjugated diene-based polymer films, vinyl alicyclic hydrocarbon polymer films, other similar resin films, and laminated films thereof. Among these, polyethylene terephthalate films, polycarbonate films, triacetyl cellulose films, norbornene-based polymer films, and the like are preferred from the viewpoint of mechanical strength, etc.

For the purpose of improving the interfacial adhesion of the base material film 11 with a layer provided on the surface of the base material film 11, one surface or both surfaces of the base material film 11 can be subjected to surface treatment, such as using primer treatment, oxidation method, or roughening method, as necessary. Examples of the oxidation method include corona discharge treatment, chromic acid treatment, flame treatment, hot-air treatment, and ozone/ultraviolet treatment. Examples of the roughening method include a sandblast method and a solvent treatment method. These surface treatment methods are appropriately selected depending on the type of the base material film 11, and the corona discharge treatment method is preferably used in view of the effect of improving the interfacial adhesion, the operability, etc. in general.

The thickness of the base material film 11 varies depending on the type and application, but is usually preferably 25 to 5,000 μm, more preferably 50 to 2,000 μm, particularly preferably 75 to 1,000 μm, further preferably 90 to 500 μm, and especially preferably 110 to 300 μm.

### (3) Pressure Sensitive Adhesive Layer

The hard coat film 1 according to the present embodiment may include a pressure sensitive adhesive layer on the surface side of the base material film 11 opposite the hard coat layer 12. The pressure sensitive adhesive constituting the pressure sensitive adhesive layer is not particularly limited, and known pressure sensitive adhesives can be used, such as acrylic-based pressure sensitive adhesives, rubber-based pressure sensitive adhesives, silicone-based pressure sensitive adhesives, and urethane-based pressure sensitive adhesives. It is preferred to use a pressure sensitive adhesive having a predetermined transparency.

When the hard coat film 1 according to the present embodiment includes the above-described pressure sensitive adhesive layer, the hard coat film 1 according to the present embodiment may have a release film laminated on the surface side of the pressure sensitive adhesive layer opposite the base material film 11. The release film is not particularly limited, provided that it has the desired release properties on its release surface (the surface in contact with the pressure sensitive adhesive layer), and known release films can be used, such as a resin film whose one surface is subjected to release treatment with a release agent.

### 2. Production Method for Hard Coat Film

The hard coat film 1 according to the present embodiment can be produced through applying the coating liquid of the anti-fingerprint composition F′ to the base material film 11 and then curing the coating layer. The method of applying and curing the coating liquid of the anti-fingerprint composition F′ is the same as that for the cured article and cured article layer according to the aforementioned embodiment.

### 3. Physical Properties of Hard Coat Film

### (1) Haze Value

The haze value of the hard coat film 1 is preferably 0% to 10%, more preferably 0.1% to 6.0%, particularly preferably 0.8% to 3.0%, and further preferably 1.5% to 2.0%. This allows the hard coat film to be suitable particularly for optical use. The haze value in the present specification refers to a value measured in accordance with JIS K7136: 2000.

### (2) Amount of Haze Value Change

When a 0.2 mass % oleic acid ethanol solution (pseudo sebum liquid) is applied to the surface of the hard coat film 1 according to the present embodiment using a wire bar #2 and allowed to dry naturally, the amount of haze value change (points) obtained by subtracting the haze value (%) before application of the pseudo sebum liquid from the haze value (%) 25 hours after the application is preferably 2.0 points or less as an upper limit, more preferably 1.5 points or less, particularly preferably 1.0 points or less, further preferably 0.5 points or less, and especially preferably 0.1 points or less, and the lower limit is most preferably 0.0 points. Since the amount of haze value change is as small as above, it can be said that the pseudo sebum liquid is absorbed into the hard coat layer 12 over time, and therefore, even if fingerprint residue is left on the surface of the hard coat film 1 (hard coat layer 12), the fingerprint residue becomes invisible over time.

### (3) Contact Angle

The oleic acid contact angle on the surface of the hard coat layer 12 of the hard coat film 1 according to the present embodiment is preferably 30° to 130°, more preferably 40° to 110°, particularly preferably 50° to 90°, and further preferably 600 to 70°. The oleic acid contact angle refers to an angle on the side including a droplet of oleic acid, among the angles formed by the tangent of the droplet at the contact part of the hard coat layer surface and the hard coat layer surface in a state in which the droplet is stationarily placed on the surface of the hard coat layer.

The water contact angle on the surface of the hard coat layer 12 of the hard coat film 1 according to the present embodiment is preferably 50° to 160°, more preferably 70° to 140°, particularly preferably 90° to 120°, and further preferably 1000 to 110°. The detailed method for measuring the above contact angle is as described in the testing example, which will be described later.

### (4) Surface Free Energy

The surface free energy of the hard coat layer 12 surface of the hard coat film 1 according to the present embodiment is preferably 1 to 40 mJ/m², more preferably 5 to 35 mJ/m², particularly preferably 10 to 30 mJ/m², and further preferably 15 to 25 mJ/m². The method for measuring the surface free energy is as described in the testing example, which will be described later.

The cured article, cured article layer, and anti-fingerprint article according to the aforementioned embodiment preferably have the same physical properties as those described above.

### 4. Use Application of Hard Coat Film

The hard coat film 1 according to the present embodiment can be used for any purpose that requires scratch resistance and fingerprint resistance, but is suitable for optical use. Specifically, the hard coat film 1 according to the present embodiment can be used as the surface layer of various displays (display bodies) such as liquid crystal displays, organic EL displays, and even touch panels. More specifically, the hard coat film 1 is preferably used by laminating it on a cover material of a display having a display body module such as a liquid crystal (LCD) module, a light emitting diode (LED) module, an organic electroluminescence (organic EL) module, etc. Lamination of the hard coat film 1 to the cover material is preferably performed by attaching it via the aforementioned pressure sensitive adhesive layer.

A display with a hard coat film can be obtained by laminating the hard coat film 1 according to the present embodiment on a display main body. Specifically, the display with a hard coat film includes the hard coat film and the display main body and is configured such that the base material film side of the hard coat film is laminated on the display surface side of the display main body. The hard coat film may be laminated directly on the display surface of the display main body, or may also be laminated on the display surface side of the display main body via one or more other members and/or layers.

It should be appreciated that the aforementioned embodiments are described to facilitate understanding of the present invention and are not described to limit the present invention. It is therefore intended that the elements disclosed in the above embodiments include all design changes and equivalents to fall within the technical scope of the present invention.

For example, one or more other layers may be interposed between the base material film 11 and the hard coat layer 12 in the hard coat film 1. Additionally or alternatively, the hard coat layer 12 may be provided on each of two surface sides of the base material film 11.

In the present specification, unless otherwise specified, the statement of “X to Y” (X and Y are arbitrary numbers) encompasses not only the meaning of “X or more and Y or less” but also the meaning of “preferably more than X” or “preferably less than Y.” In addition, unless otherwise specified, the statement of “X or more” (X is an arbitrary number) encompasses the meaning of “preferably more than X,” and the statement of “Y or less” (Y is an arbitrary number) encompasses the meaning of “preferably less than Y.”

### EXAMPLES

The present invention will be described in more detail below using examples, etc., but the scope of the present invention is not limited to these examples, etc.

### Example 1

The coating liquid of an anti-fingerprint composition with a solid content concentration of 25 mass % was obtained by mixing 100 mass parts (solid content equivalent; here and hereinafter) of a urethane-based polymer (weight-average molecular weight: 32,000, containing hydroxyl groups) as a thermosetting resin, 11.8 mass parts of acetyl tributyl citrate as a plasticizer, 18 mass parts of a nurate body of hexamethylene diisocyanate (available from Mitsui Chemicals, Inc., product name “TAKENATE D-170HN”) as a crosslinker, and 0.75 mass parts of a silicone-based leveling agent (available from BYK JAPAN KK, product name “BYK-SILCLEAN 3700,” containing hydroxyl groups) using toluene.

The coating liquid of the anti-fingerprint composition obtained above was applied to one surface of a polyethylene terephthalate film (available from Toray Industries, Inc., product name “Lumirror U48,” thickness: 125 μm) as a base material film using a wire bar #30, and the coating layer was formed by heating and drying at 120° C. for 1 minute. After that, the coating layer was stationarily placed at room temperature for 4 days to thermally cure. Thus, a 10 μm-thick coating layer was formed on the base material film, and a coating film was obtained.

The thickness of the above coating layer is a value measured using a constant-pressure thickness meter (available from TECLOCK Co., Ltd., product name “PG-02”) in accordance with JIS K7130 (here and hereinafter).

### Comparative Example 1

The coating liquid of an anti-fingerprint composition with a solid content concentration of 40 mass % was obtained by mixing 100 mass parts of a polyfunctional urethane acrylate (available from ARAKAWA CHEMICAL INDUSTRIES, LTD., product name “Beamset 577”) as an ultraviolet-curing resin, mass parts of 2,2,4-trimethyl-1,3-pentanediol diisobutyrate as a plasticizer, 0.05 mass parts of a silicone-based leveling agent (available from BYK JAPAN KK, product name “BYK-3550”), and 5 mass parts of α-hydroxyphenyl ketone as a photopolymerization initiator using propylene glycol monomethyl ether.

The coating liquid of the anti-fingerprint composition obtained above was applied to one surface of a polyethylene terephthalate film (available from Toray Industries, Inc., product name “Lumirror U48,” thickness: 125 μm) as a base material film using a wire bar #12, and the coating layer was formed by heating and drying at 70° C. for 1 minute.

Subsequently, under a nitrogen atmosphere, the above coating layer was irradiated with ultraviolet rays under the following conditions using an ultraviolet irradiation device (available from EYE GRAPHICS COMPANY, product name “EYE Grandage ECS-401GX”) to form a 5 μm thick coating layer on the base material film, and a coating film was obtained.

### «UV Irradiation Conditions»

Light source: high pressure mercury lamp
Lamp power: 2 kW
Conveyor speed: 4.23 m/min
Illuminance: 200 mW/cm²
Light amount: 200 mJ/cm²

### Comparative Example 2

A coating film was produced in the same manner as in Comparative Example 1 except that no plasticizer was compounded.

### <Testing Example 1>(Quantitative Evaluation of Fingerprint Resistance)

A 0.2 mass % ethanol solution of oleic acid as a pseudo-sebum liquid was applied to the surface of the coating layer of the coating film produced in the example and comparative examples using a wire bar #2, and then allowed to dry naturally. The oleic acid used was that available from Tokyo Chemical Industry Co., Ltd.

The haze values (%) of the above coating films were measured in accordance with JIS K7136: 2000 using a haze meter (available from NIPPON DENSHOKU INDUSTRIES CO., LTD., product name “NDH5000”) before application of the pseudo-sebum liquid, immediately after the application, and 25 hours after the application. In addition, the amount of haze value change (points) was calculated by subtracting the haze value (%) before application of the pseudo sebum liquid from the haze value (%) immediately after the application, and the amount of haze value change (points; quantitative evaluation of fingerprint resistance) was calculated by subtracting the haze value (%) before application of the pseudo sebum liquid from the haze value (%) 25 hours after the application. The results are listed in Table 1.

### <Testing Example 2>(Sensory Evaluation of Fingerprint Resistance)

Fingerprint marks made with sebum from a finger were left on the coating layer surface of the coating film produced in each of the example and comparative examples. After 25 hours, the surface of the coating film was visually confirmed under a three-wavelength fluorescent lamp, and the sensory evaluation of the fingerprint resistance was performed according to the following criteria. The results are listed in Table 1.
⊚: Fingerprint marks were barely visible.
◯: Fingerprint marks were not noticeable.
Δ: Fingerprint marks were slightly noticeable.
×: Fingerprint marks were clearly visible.

### <Testing Example 3>(Evaluation of Scratch Resistance)

The surface of the coating layer of the coating film produced in each of the example and comparative examples was rubbed 5 times back and forth over a distance of 10 cm using a #0000 steel wool with a load of 125 g/cm². The surface of the coating film was visually confirmed under a three-wavelength fluorescent lamp, and the scratch resistance was evaluated according to the following criteria. The results are listed in Table 1.
⊚: The number of scratches was 0.
◯: The number of scratches was 1 or more and 10 or less.
Δ: The number of scratches was 11 or more and 50 or less.
×: The number of scratches was 51 or more.

### <Testing Example 4>(Evaluation of Finger Slippage)

The surface of the coating layer of the coating film produced in each of the example and comparative examples was rubbed with a finger, and the finger slippage was evaluated according to the following criteria. The results are listed in Table 1.
⊚: Finger was highly slippery.
◯: Finger was slippery.
Δ: Finger was not easily slippery.
×: Finger did not slip.

### <Testing Example 5>(Measurement of Contact Angle)

The oleic acid contact angle on the surface of the coating layer of the coating film produced in each of the example and comparative examples was measured under the following conditions using a contact angle meter (available from Kyowa Interface Science Co., Ltd., product name “DM-701”). The oleic acid used was that available from Tokyo Chemical Industry Co., Ltd. The results are listed in Table 1.
Droplet volume of oleic acid: 2 μl
Measurement time: 3 seconds after dropping
Image analysis method: θ/2 method

The water contact angle on the surface of the coating layer of the coating film produced in each of the example and comparative examples was measured in the same manner as above. The conditions were as follows. The results are listed in Table 1.
Droplet volume of water acid: 2 μl
Measurement time: 3 seconds after dropping
Image analysis method: θ/2 method

### <Testing Example 6>(Measurement of Surface Free Energy)

The contact angles of various droplets on the surface of the coating layer of the coating film produced in each of the example and comparative examples were measured, and the surface free energy (mJ/m²) was obtained based on the values by the Kitazaki-Hata theory. The contact angle was measured using a contact angle meter (available from Kyowa Interface Science Co., Ltd., product name “DM-701”) using the sessile drop method in accordance with JIS R3257. For the droplets, diiodomethane was used as the “dispersion component,” 1-bromonaphthalene as the “dipole component,” and distilled water as the “hydrogen bond component.” The results are listed in Table 1.

TABLE 1

| | Fingerprint resistance | | | | | | | | | | |
|---|---|---|---|---|---|---|---|---|---|---|---|
| | | | | Amount of haze value | | | | | | | |
| | | | | change (points) | | | | | | | |
| | | | | Immediately | 25 hours | | | | | | |
| | Haze value (%) | | | after | after | | | | Contact | | Surface |
| | | Immediately | 25 hours | application − | application − | Sensory | Scratch | Finger | angle (°) | | free |
| | Before | after | after | Before | Before | evalu- | resis- | slip- | Oleic | | energy |
| | application | application | application | application | application | ation | tance | page | acid | Water | (mJ/m²) |
| Example 1 | 1.6 | 2.5 | 1.6 | 0.9 | 0.0 | ⊚ | ◯ | ⊚ | 66 | 104 | 23 |
| Comparative | 1.4 | 1.9 | 1.4 | 0.1 | 0.0 | ⊚ | X | X | 22 | 73 | 42 |
| Example 1 | | | | | | | | | | | |
| Comparative | 0.7 | 2.9 | 2.8 | 2.2 | 2.1 | X | ⊚ | Δ | 27 | 74 | 43 |
| Example 2 | | | | | | | | | | | |

As apparent from Table 1, the coating film (hard coat film) produced in the example exhibited excellent scratch resistance and fingerprint resistance, and the finger slippage was also excellent.

### INDUSTRIAL APPLICABILITY

The anti-fingerprint composition, cured article, cured article layer, anti-fingerprint article, and hard coat film according to the present invention are suitably used as the surface layer or the like of a touch panel that requires scratch resistance and fingerprint resistance.

### DESCRIPTION OF REFERENCE NUMERALS

1 . . . Hard coat film
11 . . . Base material film
12 . . . Hard coat layer

1. An anti-fingerprint composition comprising:
at least one selected from a polyfunctional (meth)acrylate-based monomer, a (meth)acrylate-based prepolymer, and a urethane-based polymer; and
a plasticizer,
wherein when a cured article layer having a thickness of 10 μm and formed by curing the anti-fingerprint composition is formed on a polyethylene terephthalate film having a thickness of 125 μm and a surface of the cured article layer is rubbed back and forth 5 times over a distance of 10 cm using a #0000 steel wool with a load of 125 g/cm², the number of scratches generated is 10 or less.

2. The anti-fingerprint composition according to claim 1, wherein it contains a crosslinker.

3. A cured article formed by curing the anti-fingerprint composition according to claim 1.

4. A cured article layer formed by curing the anti-fingerprint composition according to claim 1 in a layered form.

5. An anti-fingerprint article having the cured article layer according to claim 4 on its surface.

6. A hard coat film comprising:
a base material film; and
a hard coat layer provided on at least one surface side of the base material film,
wherein the hard coat layer is formed by curing an anti-fingerprint composition containing:
at least one selected from a polyfunctional (meth)acrylate-based monomer, a (meth)acrylate-based prepolymer, and a urethane-based polymer; and
a plasticizer,
wherein when a surface of the hard coat layer is rubbed back and forth 5 times over a distance of 10 cm using a #0000 steel wool with a load of 125 g/cm², the number of scratches generated is 10 or less.

7. The hard coat film according to claim 6, wherein the anti-fingerprint composition contains a crosslinker.

8. The hard coat film according to claim 6, wherein the hard coat layer has a thickness of 0.5 μm or more and 50 μm or less.

9. The hard coat film according to claim 6, wherein it is for optical use.
